(19) United States
(12) Patent Application Publication
(10) Pub. No.: US 2006/0186093 A1
(43) Pub. Date: Aug. 24, 2006

(54) Method and Device for Producing Metal Composite Block Material

(75) Inventors: Lothar Pleugel, Iserlohn (DE); Meinolf Wortmann, Balve (DE)

Correspondence Address: GUDRUN E. HUCKETT DRAUDT, LONSSTR. 53, WUPPERTAL, 42289, DE

(73) Assignee: HOESCH SCHWERTER PROFILE GMBH, Schwerte (DE)

(21) Appl. No.: 11/307,753

(22) Filed: Feb. 21, 2006

(30) Foreign Application Priority Data
Feb. 22, 2005 (DE) 10 2005 008 250.5

(51) Int. Cl. B23K 15/04; B21C 23/08

(52) U.S. Cl. 219/121.14

(57) ABSTRACT

In a method for producing metal composite block material, the joining surfaces of composite block elements are machined by machine-cutting to a metallically bright state. Subsequently, the composite block elements are joined by electron beam welding to a composite block material. The composite block material is formed by steel extrusion to a composite pipe.

### BACKGROUND OF THE INVENTION

The invention relates to a method for manufacturing metal composite block material (billet, slab) from separately manufactured composite block elements.

In the industrial field of thermal-chemical process technology pipes are used that are comprised of at least two different metallic materials for fulfilling often complex process requirements in corrosive thermal environments. For example, the outer part of such pipes, referred to also as composite pipes, can be comprised preferably of an austenitic corrosion-resistant material in order to provide corrosion protection, while the inner pressure-conducting pipe part is made of heat-resistant carbon steel. The reverse arrangement of the pipe material components is also known for certain applications.

Composite pipes are used primarily in the boiler area of waste incinerators of waste-fueled power plants. They are moreover used in connection with lye recovery devices in the pulp industry—in the black liquor recovery boiler of the Kraft process—and moreover as heat exchanger pipes in thermal catalytic cleavage processes.

There are essentially two methods for producing such composite pipes. The first approach via composite block material—the forming-technological prestage of pipe manufacture—is characterized in that the aforementioned exemplary material combination of austenitic/carbon steel is already arranged in a defined state in the blank. During the subsequent hot forming process of the composite block material, a composite pipe of at least two different steel materials is produced that are bonded to one another. In this connection, the wall thickness proportion of each steel material component in regard to the total wall thickness of the finished composite pipe must be taken into consideration already during composite material construction by taking into account the material-specific flow behavior during hot forming.

The second approach for manufacturing composite pipes is the so-called cladding of pipes that is based on welding technology. The pipes are produced initially by conventional methods. During cladding, the additional material component is applied onto the pipe surface by welding by means of a fusion welding process until the desired layer thickness of generally a few millimeters has been reached. In the prior art, cladding is realized either automatically by an automated process or by hand.

In all types of composite pipe manufacture it is important that between the individual material components of the pipe a metallic bonding can be produced in a reproducible way. This metallic bond, that should not be destroyed during cold forming processes to which the pipes are subjected during the course of further processing, ensures that in operational use thermal conduction through the entire pipe wall is optimal and that no efficiency loss will occur when the pipes are used in boilers.

In a method for composite block material manufacture in accordance with U.S. Pat. No. 6,242,112, a second liquid material component is applied by means of gas atomizing to deposit finely distributed metal droplets onto a round rod or pipe made of carbon steel. This spraying method that is also referred to as Osprey technology is disclosed in detail in U.S. Pat. No. 3,826,301 and G.B. 1,472,939. The spray-formed (Osprey) composite block material produced in this way is subsequently formed by extrusion to a composite pipe.

U.S. Pat. No. 6,296,953 discloses a method for composite material manufacture in which the two material components of the future composite pipe is first conventionally rolled by hot rolling to round rods of different diameters. After hot rolling, the round rods are cut to length and provided with concentric longitudinal bores in such a way that the round rod with the greater diameter has a bore into which the round rod of the smaller diameter can be inserted. After positioning of the smaller round rod in the bore of the greater rod, this combination is formed by hot extrusion to a composite pipe.

U.S. Pat. No. 4,630,351 discloses a method for manufacturing seamless externally clad steel pipes by extrusion wherein a composite block material is produced in such a way that a high-alloy cladding material is welded in a pre-determined thickness onto an appropriate round core material. After prior drilling of the core material, forming of the composite material to a composite pipe by extrusion and/or cold pilger rolling is carried out.

U.S. Pat. No. 4,795,078 discloses a method for producing composite pipes in which two or three individual pipes are first heated to different temperatures and are then inserted into one another for producing a shrink fit. Subsequently, by means of an electron beam welding device on both end faces of the pipe a seal-tight welding seam is applied on the end face edges of the individual pipes for connecting the individual pipes to one another. Subsequently, the pipe is inserted into a high-temperature isostatic press. In the argon atmosphere of the press, a metallurgical bonding to the pipe boundaries of the composite pipe takes place; subsequently, the composite pipe is subjected to a stretching process.

In JP 06170534 A an automatic cladding method for welding high-alloy steel material onto the outer pipe surface is disclosed; JP 09314384 discloses a device for cladding pipes on the interior. The disadvantage of cladding is that, as a result of the process, the fusion welding process always causes intermixing to a greater or lesser degree of the base material of the pipe and the applied high-alloy material. This leads to changes of the chemical and mechanical material properties. Aside from the welding parameters, the mixing effect depends on the root penetration, the average layer thickness, and the number of layers. Moreover, the cladding process produces more or less rough pipe surfaces on which combustion and reaction products adhere and which can be of the point of origin of cracks as a result of stress concentration.

When employing the composite block material technology, a smooth pipe surface can be generated already by extrusion. Also, excessively strong mixing is prevented in general.

The disadvantage of composite block material technology based on spray-forming is that a special manufacturing method must be employed that is complex and not always available. Also, the nature of the composite block manufacture based on spray-forming requires a certain excess of material and a minimum number of manufactured pieces that may not be too small.

When the composite block technology is based on joining conventionally produced composite block elements, three different technical criteria must be fulfilled:

1. It should be possible to manufacture the composite block element that forms the outer or inner area of the composite block (that can be viewed as a tick-wall pipe) with minimal material waste.

2. The manufacturing method must ensure an always optimal metal bonding without any disruptive oxide layer between the material components.

3. The individual material components of the composite block material must be position-stable relative to one another so that they survive the hot forming process without any damage.

### SUMMARY OF THE INVENTION

It is an object of the present invention to propose a method with which an inexpensive and at the same time qualitatively superior manufacture of composite pipes can be ensured. In this connection, preferably easily available possibilities of semi-finished product manufacture are to be used and material waste should be minimized.

In accordance with the present invention, this is achieved in that the composite block elements are machine-cut at their joining surfaces to a metallically blank or bright state and subsequently are joined by electron beam welding to a composite block material and the composite block material is subsequently formed by steel extrusion to a composite pipe.

In this connection, the manufacture of metal composite block material from steel is realized by joining initially separately manufactured composite block elements whose boundary surfaces are machine-cut to a metallically blank or bright state before joining. This is realized by machine-cutting the surfaces preferably at such dimensional tolerances that the composite block elements can be easily inserted into one another. In a subsequent step the elements are then fixedly connected to one another to form a composite block material (billet, slab) by partial electron beam welding (EB welding). The composite block material is then formed subsequently on a steel extrusion device to a composite pipe.

Advantageous embodiments of the method according to the invention are disclosed in the dependent claims.

### BRIEF DESCRIPTION OF THE DRAWING

FIG. 1 shows two composite block elements 1 and 2 having outer diameters D_{A} and dₐ, wall thickness S, wherein the diameter dₐ of element 2 fits barely in the bore D_{I} of element 1, and the composite block element 2 has a central bore 7 with diameter dᵢ.

FIG. 2 shows a schematic of an electron beam welding device for composite block material, comprising a vacuum chamber 11, electron beam generator 12, electron beam 13, composite block material 4 to be welded, a manipulation device 15, vacuum pump station 16, and device control 17.

FIG. 3 shows a composite block material joined by electron beam welding having outer diameter D_{A}, inner bore dᵢ, and diameters D_{I} and dₐ that are fixedly connected to one another by the welding process.

FIG. 4 shows the composite block material according to FIG. 3 in longitudinal section; L_{EB} is the composite block material length joined by electron beam welding; L_{PS} is the length portion of the joined but not welded composite block material, and L is the total length of the composite block material.

FIG. 5 shows in a simplified section illustration details of driving the composite block material through a steel extruder.

FIG. 6 shows an external composite block element 1 having diameter D_{A} and Dᵢ and wall thickness S, which element 1 has been cold formed based on sheet metal technology and has been joined by beam welding at the welding location 6 to a thick-wall pipe.

FIG. 7 is an external composite block element 1 having a layered arrangement and being comprised of three different elements or layers 1a, 1b, and 1c.

FIG. 8 is a detail illustration of the detail VIII of FIG. 7.

### DESCRIPTION OF THE PREFERRED EMBODIMENTS

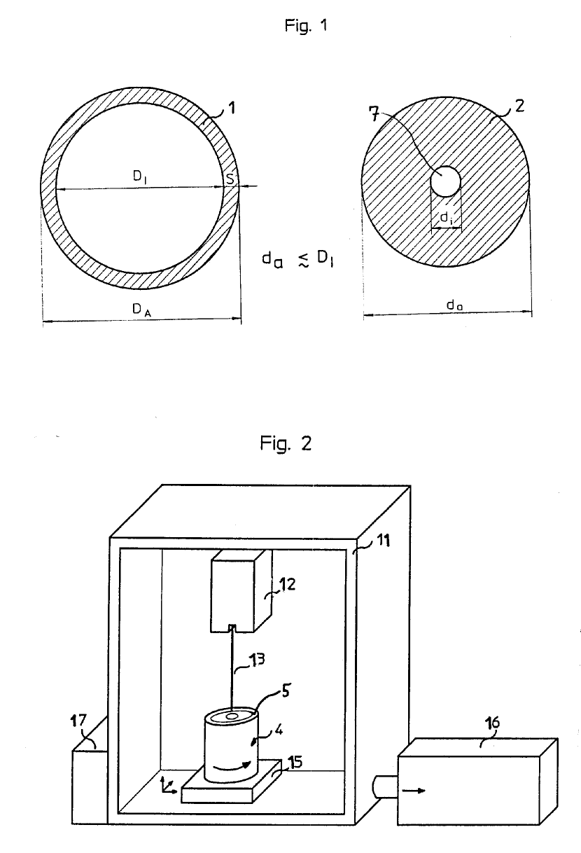

When producing the composite block elements 1, 2 illustrated in FIG. 1, workpiece preparation is carried out in a first manufacturing step. For this purpose, the bore surface in accordance with D_{I} of the future outer element 1 and the outer surface in accordance with dₐ of the future inner element 2 are machine-cut to a metallically blank or bright state, free of decarburization and clean. This is realized by a machine-cutting process, preferably by a turning process, of the two joining surfaces with subsequent cleaning. The surfaces are then free of flaws such as the decarburization or edge oxidation.

A diameter difference of D_{I}−dₐ of approximately 0.2 mm to 0.4 mm as a result of the machine-cutting process is desirable in view of a favorable geometric configuration of the joining gap for the later electron beam welding process (EB welding).

For such a tolerance range of the joining surfaces, the elements 1, 2 can be inserted into one another without problem. Special auxiliary steps such as, for example, prior heating of the outer element 1, are not required.

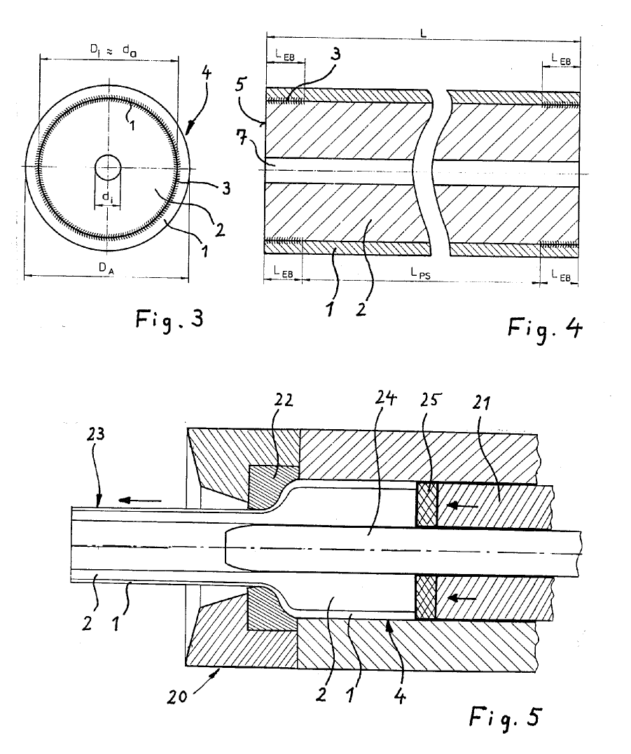

After completion of workpiece preparation and insertion, partial electron beam welding is carried out in accordance with the schematic illustrated in FIG. 2. In this connection, without welding filler material, on both end faces 5 of the composite block material 4 (compare FIG. 3) a concentric electron beam (EB) welding seam 3 is generated at D_{I} and dₐ which welding seam, as a result of the adjusted welding parameters, penetrates to the preselected weld depth L_{EB} (see FIG. 4) into the composite block material 4. The weld depth L_{EB} is less than 100 mm, preferably it is approximately 50 mm.

Partial EB welding as an essential manufacturing step of the method according to the invention has the following advantages:

1. The electron beam welding process is the only fusion welding process that is able to penetrate without welding filler material very deep into the material to be welded (in the case of steel to a weld depth of approximately 150 mm) and that generates in this connection a welding seam of only a few tenths of a millimeter. Because of this characteristic property of electron beam welding, two important requirements for the method according to the invention are realized:

a) a satisfactory weld depth L_{EB}=100 mm is generated that provides sufficient mechanical strength so that the strong shearing forces that occur during extrusion between the composite block elements 1, 2 can be taken up safely without the elements 1, 2 being torn apart;

b) sufficiently narrow welding seams 3 are produced so that mixing of the materials at the joining area can be significantly reduced and the original workpiece properties are hardly negatively affected.

2. Electron beam welding, aside from the special case of atmospheric electron beam welding, is carried out in industrial welding devices at fine vacuum up to high vacuum. The system pressures are accordingly in the range of 10⁻² mbar to approximately 5×10⁻⁴ mbar. In this pressure range the partial pressure of oxygen in the gas chamber is so minimal that noticeable metal oxidation in the joining area L_{EB} joined by electron beam welding is precluded.

3. The composite block material area of the length L_{PS} according to FIG. 4, in contrast to the zones of the length L_{EB}, is not joined by electron beam welding. Accordingly, any type of intermixing between the different material components is prevented. In this area, the proper metallic bonding required for the final product is achieved only at the time of forming the composite block material by the future steel extrusion as a result of the effect of pressure welding (diffusion effect under the action of pressure and temperature). However, for this material processing step it is also true that the low partial pressure of oxygen that has been preserved from the electron beam welding process is the prerequisite for an oxidation-free joining area and therefore the prerequisite for an optimal metal bonding between the workpiece components of the composite pipe. To this is added the advantageous effect of the prepared blank or bright metal joining surfaces as a result of the first step carried out by machine-cutting.

After completion of the EB welding process the steel extrusion of the composite block material 4 is carried out; the steel extrusion step is important for the present invention. For this purpose, the composite block material is first heated to a temperature between 1,100 degrees Celsius and 1,300 degrees Celsius and preferably between 1,150 degrees Celsius and 1,250 degrees Celsius; the heated material is inserted into the extruder 20 illustrated schematically in FIG. 5. The plunger 21 of the steel extruder has a front end pressure disk 25 and drives the composite block material 4 at very high pressure of approximately 5,000 bar through a die 22 of the extruder. Because of the very fast advancing action of the stamp 21, an almost instant forming of the material upon passing through the die 22 is realized. The reduced profiled pipe section 23 exiting from the die 22 is the final product produced by the method of the invention. In order to prevent a complete filling of the profiled pipe 23 formed in the extruder, the extruder 20 is provided additionally with a central arbor 24 that extends into the plane of the die 22. The diameter of the arbor 24 determines essentially the inner diameter of the pipe section 23 exiting from the extruder 20.

The entire pressing process of the composite block material 4 takes only a few seconds. Because of the speed of the processes that are being performed, an excellent metallurgical joint having high thermal and mechanical load resistance is provided at the boundary surface between the two individual elements 1, 2 of the composite block material as a result of the pressure-enhanced diffusion processes. In the die 22 an approximately 20-fold hot forming of the composite block material 4 having an initial length of approximately 0.7 to 1.5 m can be achieved.

The special advantage of the extrusion process resides therefore in the diffusion-caused metallurgical processes that are performed in fractions of a second. As a result of the extremely fast plastifying deformation the boundary surfaces of the individual elements 1, 2 are extremely enlarged. In this way, fresh boundary surfaces are produced whose outer atoms are neither impaired by neighboring metal atoms nor by atoms of third contaminating substances in their reactivity. The high pressure (corresponding to the smallest atom distances of the reaction partners relative to one another) and the high reactivity of the atoms in the newly formed boundary surfaces lead to the diffusion-based bonding process achieved by the inventive method to be derived from the aforementioned short processing time.

In addition to its main task of the forming the composite block material 4 to the composite pipe, the extrusion process which is part of the process chain according to the invention can provide the additional effect that the compound block elements 1, 2 can be produced with reduced waste of expensive material. For example, it is possible that the outer composite block element 1 can be produced by an axial punching process in accordance with the method of indirect pressing carried out on the extruder instead of by drilling or internal turning of the inner diameter D_{I}. While in the case of a cutting process by drilling, when supposing that conventional blank dimensions are D_{A}=170 mm and D_{I}=140 mm, a material waste of approximately 60 percent to 70 percent occurs, this can be reduced by applying the punching process inclusive of the subsequent external turning to 20 percent to 25 percent.

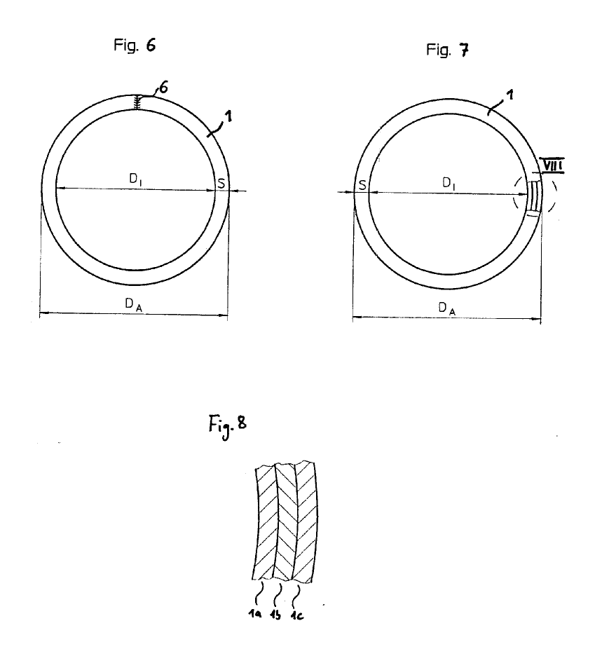

A further manufacturing alternative that saves material and thus material costs results by employing sheet metal bending techniques in combination with beam welding. According to FIG. 6, a prepared sheet metal of the desired material composition and thickness S is processed by cold forming and beam welding at the joining location 6 (FIG. 6) such that a thick-wall pipe 1 with inner diameter D_{I} and outer diameter D_{A} is produced. In accordance with FIGS. 1 through 4, this thick-wall pipe 1 can be used for manufacturing a complete composite block material 4.

In a further embodiment it is proposed that a composite block element 1 corresponding to a thick-wall pipe according to the illustration of FIG. 1 or FIG. 6 is divided into further sub-elements in accordance with detail VIII of FIG. 7. Such a solution is advantageous in connection with a composite pipe to be used in operating conditions in which the combination of thermal fatigue and stress crack corrosion represents a significant danger potential for the service life. Greatly differing thermal expansion coefficients of the outer area of the composite pipe made of austenitic steel, on the one hand, and the inner area made of carbon steel, on the other hand, can lead to a significant contribution to a disadvantageous stress level in the pipe wall. A multi-layer material configuration of the pipe wall of partial elements (layers) 1a, 1b, 1c, as illustrated in FIG. 7 and FIG. 8, that leads to smoothly stepped thermal expansion coefficients without great jumps, can provide a reduction of the stress level in the composite pipe wall and can thus prevent crack formation.

While specific embodiments of the invention have been shown and described in detail to illustrate the inventive principles, it will be understood that the invention may be embodied otherwise without departing from such principles.

What is claimed is:

1. A method for producing metal composite block material, comprising the steps of:
machining joining surfaces of composite block elements by machine-cutting to a metallically bright state;
subsequently, joining by electron beam welding the composite block elements to a composite block material;
forming the composite block material by steel extrusion to a composite pipe.

2. The method according to claim 1, wherein, in the step of joining by electron beam welding, a vacuum is employed and wherein welding seams are produced that are concentric and oxide-free and extend from end faces of the composite block material to a weld depth into the composite block material in a direction away from the end faces.

3. The method according to claim 2, wherein the weld depth has a length of 50 mm to 100 mm.

4. The method according to claim 2, wherein the weld depth is selected to provide a sufficient mechanical strength to withstand the subsequent step of forming by steel extrusion, wherein a length portion of a total length of the composite block material is not welded and free of any intermixing between materials of the composite block elements, wherein the length portion extend across most of the total length.

5. The method according to claim 4, wherein metal bonding across the length portion is generated in the step of forming by steel extrusion by pressure-controlled and temperature-controlled diffusion processes caused by a pressure welding effect.

6. The method according to claim 5, wherein the metal bonding generated by pressure-controlled and temperature-controlled diffusion processes caused by the pressure welding effect is qualitatively not affected by oxide formation as a result of low partial pressure of oxygen.

7. The method according to claim 1, wherein the step of joining by electron beam welding is carried out in a vacuum of 10⁻² mbar to 5×10⁻⁴ mbar.

8. The method according to claim 1, comprising the step of producing the composite block elements by sheet metal bending and beam welding.

9. The method according to claim 1, comprising the step of producing the composite block elements in a layered arrangement comprising layers of steel materials having different thermal expansion coefficients that are matched relative to one another to reduce a stress level of the composite block material.

10. The method according to claim 1, comprising the step of producing the composite block elements by indirect punching extrusion followed by subsequent external turning.

11. The method according to claim 10, wherein the step of joining by steel extrusion and the step of punching extrusion are carried out on the same extruder.

12. The method according to claim 1, wherein in the step of joining by steel extrusion the composite block material is heated to a temperature of 1,150 degrees Celsius to 1,250 degrees Celsius.

13. The method according to claim 1, wherein in the step of joining by steel extrusion a centrally arranged arbor is used.
